(19) United States
(12) Patent Application Publication
(10) Pub. No.: US 2009/0162815 A1
(43) Pub. Date: Jun. 25, 2009

(54) ZI WEI DOU SHU ANALYZING SYSTEM AND METHOD THEREOF

(76) Inventor: Chien-Chung Chen, Taipei (TW)

Correspondence Address: KILE GOEKJIAN REED & MCMANUS, 1200 NEW HAMPSHIRE AVE, NW, SUITE 570, WASHINGTON, DC, 20036, US

(21) Appl. No.: 12/342,831

(22) Filed: Dec. 23, 2008

(30) Foreign Application Priority Data
Dec. 24, 2007 (TW) 96149719

(51) Int. Cl. G09B 19/00

(52) U.S. Cl. 434/106

(57) ABSTRACT

An analyzing method of a zi wei dou shu system is disclosed. The method includes the steps of: generating a birth chart according to personal information of a user; quantifying the information in the birth chart; drawing a period of fortune trend curve based on transits of time, whereby the user can refer to numerical information to interpret his/her own fortune.

### CROSS-REFERENCE TO RELATED APPLICATION

This application claims priority under 35 U.S.C. §119 to Taiwan Patent Application No. 096149719, filed on Dec. 24, 2007, in the Taiwan Intellectual Property Office, the entire contents of which are hereby incorporated by reference.

### BACKGROUND OF THE INVENTION

1. Field of the Invention

The present invention relates to an old Chinese Astrologic system, and more particularly to a Zi Wei Dou Shu analyzing system and method thereof for analyzing fortune or foretelling the future.

2. Description of Related Art

Based on curiosity and fear of the unknown, people enjoy the old Chinese Astrologic and wish to foresee their future through the old Chinese Astrologic for tending towards luck and avoiding hardship. Zi Wei Dou Shu is one of the most important achievements of Chinese traditional numerology, which not only predicts the good or the bad outcome based on the motion of constellations, but also studies human nature according to the combination of constellations. Zi Wei Dou Shu has proved to be reasonable throughout the centuries, and thus enjoys a high degree of trust among the public.

It is complicated to generate a birth chart using Zi Wei Dou Shu. Besides determining the locations of heavenly stems, earthly branches, life and body spheres palaces, the five elements, and the location of Zi Wei Star (also known as Polaris), the locations of other major stars and auxiliary stars also need to be arranged according to many complicated formulas. Thus, many computer programs have been written for generating birth charts to replace the above complicated steps.

Please refer to FIG. 1 illustrating a conventional arrangement result of a birth chart. The ancients believed that the heaven was round and the earth was square and always faced south to draw, so a square birth chart was listed according to the orientation order of the twelve earthly branches. For organization, each square on the grid will be named and respectively representing an aspect of the person's fortune, which is represented by the 12 “Palaces” (also commonly known as “Gōng” or “house”), and each square is called a Palace grid. The term Palaces originated from the concept of house or temple or a space where spirits or souls live in. In addition, there is a 13th name for Palace called (Shēn Gōng) or literally, Body Palace. Therein, Body Palace means acquired life and is used to compare with innate life, and the Body Palace co-exists with one of the 12 outer squares of the Palace grid. It is as important as any of the other 12 Palaces in interpreting one's life events. As shown in FIG. 1, a birth chart 1 includes a center Palace grid 11 and twelve Palace grids 13 around the center Palace grid 11. The center Palace grid 11 is used for recording. Each Palace grid 13 has a name 131 for defining a Palace address, a constellation 133 located in the Palace address, and a heavenly stem and earthly branch 135. Users can interpret their fortune according to the birth chart. However, the fortune is decided not only by the location of the constellation with in the Palace address, but also by related information such as transits of time, major (10-year) and minor (1-year) time frame of life, combination of constellation within each palace, three-way compatibility factor (also known as triplicity), four transforms of stars that is based on heavenly stems of each year, and some special arrangement of stars and so on, so the analysis is very complicated and needs to be performed by professionals.

Additionally, even if a birth chart has been analyzed in detail for a user for the moment by a numerologist, the user still cannot convert the constellations in the birth chart into fortune information for the future.

### SUMMARY OF THE INVENTION

Accordingly, the present invention uses numerical values to express degrees of influence for every constellation in a birth chart, amends the numerical values in the birth chart according to transits of time, such as the year, month, day, or even hour, and then shows a calculated fortune analysis result in a numerical way, thereby analyzing fortune simply and accurately.

An object of the present invention is to provide a Zi Wei Dou Shu analyzing system and method thereof for analyzing fortune simply and accurately.

To achieve the above-mentioned object, a Zi Wei Dou Shu analyzing system in accordance with the present invention is provided. The system includes an operation interface, a storage module, and a central processing unit. The operation interface includes an input unit and a display unit, wherein the input unit is used for a user inputting his personal information and the display unit is used for displaying operation screens of the Zi Wei Dou Shu analyzing system. The storage module specially stores a constellation intensity database and analyzing software. The constellation intensity database records influence degrees of a plurality of constellations to every Palace address in different Palace grids. The central processing unit is coupled between the operation interface and the storage module for running the analyzing software and collocating (i.e. to arranging in groups) the data of the constellation intensity database based on the personal information so as to generate a fortune analyzing result.

The Zi Wei Dou Shu analyzing software includes: a chart generation program which generates a birth chart according to the personal information, wherein the birth chart includes a center Palace grid and a plurality of Palace grids around the center Palace grid and lists the personal information and names of the Palace addresses and the constellations which fall into the Palace grids; a birth chart quantifying program which searches the constellation intensity database and converts information in the birth chart into numerical values according to a numerical value in every Palace grid of every constellation occurring in the birth chart, thereby generating a quantified birth chart; and a fortune analyzing program which amends the quantified birth chart according to the transits of time, such as the year, month, day, or hour, so as to generate a fortune analyzing table.

The present invention further provides a Zi Wei Dou Shu analyzing method adapted for operating on a terminal unit. The terminal unit has a storage medium for storing a Zi Wei Dou Shu analyzing software. The analyzing method includes the steps of: running a Zi Wei Dou Shu analyzing software and inputting personal information; running a chart generation program to generating a birth chart according to the personal information; using numerical values to express influence degrees of every constellation occurring in the birth chart thereby generating a quantified birth chart; and amending the quantified birth chart according to transits of time, such as the year, month, day, or hour, so as to generate a fortune analyzing table.

To further understand manners, means, and efficacy of the present invention, please refer to the following detailed description and drawings related the present invention. Other objects and advantages of the present will also be described in the following detailed description and drawings.

### BRIEF DESCRIPTION OF THE DRAWINGS

FIG. 1 is a schematic view of a conventional arrangement result of a birth chart;

FIG. 2 is a schematic view of a system framework of one embodiment of a Zi Wei Dou Shu analyzing system of the present invention;

FIG. 3 is a schematic view of an operation interface of one embodiment of the Zi Wei Dou Shu analyzing system of the present invention;

FIG. 4 is a schematic view of a birth chart of one embodiment of the Zi Wei Dou Shu analyzing system of the present invention;

FIG. 5 is a schematic view of a quantified birth chart of one embodiment of the Zi Wei Dou Shu analyzing system of the present invention;

FIG. 6-16˜2 are schematic views of a fortune analyzing table of one embodiment of the Zi Wei Dou Shu analyzing system of the present invention; and

FIG. 7 is a flow chart of a Zi Wei Dou Shu analyzing method of the present invention.

### DETAILED DESCRIPTION OF PREFERRED EMBODIMENTS

A Zi Wei Dou Shu analyzing system and method thereof of the present invention uses numerical values to express influence degrees of every constellation in a birth chart to Palace addresses and then amends the numerical values in the birth chart according to the transits of time, such as the year, month, day, or hour, so as to generate an accurate fortune trend.

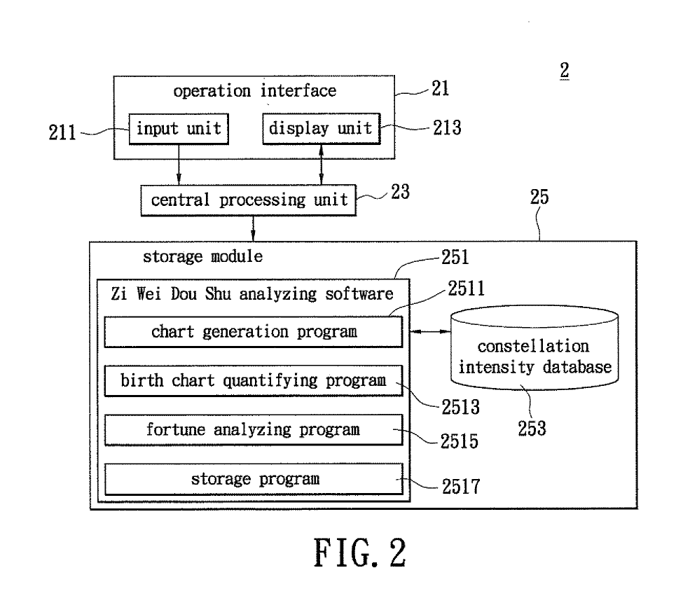

At first, please refer to FIG. 2 illustrating a system framework of a Zi Wei Dou Shu analyzing system according to an embodiment of the present invention. As shown in FIG. 2, the Zi Wei Dou Shu analyzing system 2 includes an operation interface 21, a storage module 25, and a central processing unit 23. The operation interface 21 includes an input unit 211 and a display unit 213, wherein the input unit 211 is used for a user inputting his personal information and the display unit 213 is used for displaying operation screens of the Zi Wei Dou Shu analyzing system. The storage module 25 specially stores a constellation intensity database 253 and a Zi Wei Dou Shu analyzing software 251. The central processing unit 23 is coupled between the operation interface 21 and the storage module 25 and used for running the Zi Wei Dou Shu analyzing software 251 and collocating the constellation intensity database 253 based on the personal information to generate a fortune analyzing result.

The constellation intensity database 253 records the influence degrees of a plurality of constellations to each Palace address when the constellations are in different Palace grids and the influence degrees of combination states of each constellation to the fortune. The combination states of the constellations include Hui (good stars at opposite palace), He (stars at triplicity), Yu (same time), Tong (stars at same palace), Feng (similar time), Zuo (stars locate at specified palace), Chong (bad stars at opposite palace), Zhao (shine on), Jia¹ (add), Jia² (clip by similar type of stars at neighbor palace), An He (palaces that are at the same horizontal grids), and Du Zuo (only one star in a palace) . . . etc. Taking Table 1 and Table 2 which are recorded in the database 253 for example, the influence degrees of the constellations to the Palace addresses in different Palace grids are expressed in a numerical mode. The intensities of the constellations are one very important attribute which affects the fortune. The intensity attributes are generally divided into Miao (brighter), Wang (bright), De Di (less bright), Li Yi(normal), Ping He (less dark), Bu De Di (dark), Luo Xian (Shi Xian) (darker), 7 levels of brightness, and so on according to different Palace grids and combination states, such as the constellation falling into the southern (Si or Wu) Palace grid (also means summer, noon time), the attribute of Tai Yang star (sun) is Miao or Wang (brighter or bright) and the attribute of Tai Yin star (moon) is Luo Xian (darker). Even if each constellation has the attribute of Miao or Wang (brighter or bright), it still needs to amend the intensity depending on the Palace grid that the constellation falls into. As shown in Table 1 and Table 2, the intensity attribute of Zi Wei star (also known as Polaris) is Ping (meaning less dark) in the time period from 23:00 PM to 1:00 AM (Zi) and converted into the numerical value of 1.0 in Table 2. The way of converting the attributes of other constellations into the numerical values is also similar to it. The numerical values defined in the constellation intensity database 253 have been verified in practice for years. The numerical values are expressed in a relative numerical way, and the numerical magnitudes and ranges of the numerical values can be amended according to actual demands and aren't fixed.

TABLE 1

| | zi | chou | yin | mao | chen | si | wu | wei | shen | you | xu | hai |
|---|---|---|---|---|---|---|---|---|---|---|---|---|
| ziwei | ping | miao | miao | wang | di | wang | ping | miao | wang | wang | di | wang |
| lianzhen | ping | li | miao | ping | li | xian | ping | li | miao | ping | li | xian |
| tiantong | wang | bu | li | miao | ping | miao | xian | bu | wang | ping | ping | miao |
| wuqu | wang | miao | di | li | miao | ping | wang | miao | di | li | miao | ping |
| taiyang | xian | bu | wang | miao | wang | wang | miao | di | di | ping | bu | xian |
| tianji | miao | xian | di | wang | miao | ping | miao | xian | di | wang | miao | ping |
| tianfu | miao | miao | miao | di | wang | di | wang | miao | di | wang | wang | di |
| taiyin | miao | miao | xian | xian | xian | xian | bu | di | li | wang | wang | miao |
| tanlang | wang | li | ping | di | miao | xian | wang | miao | ping | li | miao | xian |
| jumen | wang | wang | miao | miao | ping | ping | wang | ping | miao | miao | ping | wang |
| tianxiang | miao | miao | miao | xian | ping | di | di | di | miao | xian | di | di |
| tianliang | miao | wang | miao | di | miao | xian | miao | wang | xian | di | di | xian |
| qisha | li | miao | miao | wang | di | ping | wang | miao | miao | wang | miao | ping |
| pojun | miao | wang | miao | xian | wang | ping | miao | wang | miao | xian | wang | ping |
| wenchang | di | miao | xian | wang | di | miao | xian | li | di | miao | xian | li |
| wenqu | miao | miao | ping | wang | miao | miao | xian | wang | di | miao | xian | wang |
| tuoluo | di | miao | bu | xian | miao | xian | li | miao | ping | xian | miao | di |
| lucun | miao | li | di | miao | li | di | miao | li | di | miao | li | di |
| qingyang | wang | miao | xian | xian | miao | xian | xian | miao | wang | wang | miao | wang |
| huoxing | xian | di | miao | li | xian | di | miao | li | xian | di | miao | li |
| lingxing | xian | xian | miao | miao | di | di | miao | di | di | xian | miao | xian |

TABLE 2

| zi | chou | yin | mao | chen | si | wu | wei | shen | you | xu | hai |
|---|---|---|---|---|---|---|---|---|---|---|---|
| 1.0 | 5.0 | 5.0 | 4.0 | 3.0 | 4.0 | 1.0 | 5.0 | 4.0 | 4.0 | 3.0 | 4.0 |
| 0.0 | 0.6 | 2.4 | 0.0 | 0.6 | (1.2) | 0.0 | 0.6 | 2.4 | 0.0 | 0.6 | (1.2) |
| 2.0 | 0.0 | 1.0 | 2.5 | 0.5 | 2.5 | (0.5) | 0.0 | 2.0 | 0.5 | 0.5 | 2.5 |
| 3.0 | 4.0 | 2.0 | 1.0 | 4.0 | 0.0 | 3.0 | 4.0 | 2.0 | 1.0 | 4.0 | 0.0 |
| (2.0) | (1.2) | 2.0 | 2.8 | 2.0 | 2.0 | 2.8 | 1.2 | 1.2 | (0.4) | (1.2) | (2.0) |
| 3.0 | 0.0 | 2.0 | 2.5 | 3.0 | 1.0 | 3.0 | 0.0 | 2.0 | 2.5 | 3.0 | 1.0 |
| 3.0 | 3.0 | 3.0 | 1.0 | 2.0 | 1.0 | 2.0 | 3.0 | 1.0 | 2.0 | 2.0 | 1.0 |
| 2.8 | 2.8 | (2.0) | (2.0) | (2.0) | (2.0) | (1.2) | 1.2 | 0.4 | 2.0 | 2.0 | 2.8 |
| 1.8 | 0.6 | 0.0 | 1.2 | 2.4 | (1.2) | 1.8 | 2.4 | 0.0 | 0.6 | 2.4 | (1.2) |
| 2.0 | 2.0 | 3.0 | 3.0 | (1.0) | (1.0) | 2.0 | (1.0) | 3.0 | 3.0 | (1.0) | 2.0 |
| 3.0 | 3.0 | 3.0 | 0.0 | 1.0 | 2.0 | 2.0 | 2.0 | 3.0 | 0.0 | 2.0 | 2.0 |
| 3.0 | 2.5 | 3.0 | 2.0 | 3.0 | 0.0 | 3.0 | 2.5 | 0.0 | 2.0 | 2.0 | 0.0 |
| 0.6 | 2.4 | 2.4 | 1.8 | 1.2 | 0.0 | 1.8 | 2.4 | 2.4 | 1.8 | 2.4 | 0.0 |
| 2.4 | 1.8 | 2.4 | (1.2) | 1.8 | 0.0 | 2.4 | 1.8 | 2.4 | (1.2) | 1.8 | 0.0 |
| 1.8 | 3.0 | (0.6) | 2.4 | 1.8 | 3.0 | (0.6) | 1.2 | 1.8 | 3.0 | (0.6) | 1.2 |
| 3.0 | 3.0 | 0.6 | 2.4 | 3.0 | 3.0 | (0.6) | 2.4 | 1.8 | 3.0 | (0.6) | 2.4 |
| (2.0) | (1.0) | (3.5) | (4.0) | (1.0) | (4.0) | (2.5) | (1.0) | (3.0) | (4.0) | (1.0) | (2.0) |
| 2.8 | 1.0 | 1.6 | 2.8 | 1.0 | 1.6 | 2.8 | 1.0 | 1.6 | 2.8 | 1.0 | 1.6 |
| (1.5) | (1.0) | (4.0) | (4.0) | (1.0) | (4.0) | (4.0) | (1.0) | (1.5) | (1.5) | (1.0) | (1.5) |
| (4.0) | (2.0) | (1.0) | (2.5) | (4.0) | (2.0) | (1.0) | (2.5) | (4.0) | (2.0) | (1.0) | (2.5) |
| (4.0) | (4.0) | (1.0) | (1.0) | (2.0) | (2.0) | (1.0) | (2.0) | (2.0) | (4.0) | (1.0) | (4.0) |

The Zi Wei Dou Shu analyzing software 251 includes a chart generation program 2511, a birth chart quantifying program 2513, a fortune analyzing program 2515 and a storage program 2517. The chart generation program 2511 generates a birth chart according to the personal information of a user. The birth chart includes a center Palace grid and twelve Palace grids around the center Palace grid. The birth chart lists the personal information and the constellations falling into the Palace grids. The birth chart quantifying program 2513 searches the constellation intensity database 253 and amends the numerical value in every Palace grid of every constellation occurring in the birth chart according to the combination states of the constellations, and thereby generating a quantified birth chart. The fortune analyzing program 2515 amends the quantified birth chart according to the transits of time, such as the year, month, day, or hour, so as to generate a fortune analyzing table. The storage program 2517 is used for storing the personal information, the birth chart, the quantified birth chart, and the fortune analyzing table etc.

Concretely, the Zi Wei Dou Shu analyzing system 2 is adapted for operating on a terminal unit which runs procedure code segments of the Zi Wei Dou Shu analyzing software 251 to determine the fortune. The terminal unit includes a desktop personal computer (PC), a notebook computer, a server, an ultra mobile personal computer (UMPC), a smartphone, a personal digital assistant (PDA), or a terminal device related to wireless transmission. Furthermore, the display unit 213 is selected from a liquid crystal display (LCD), an organic light-emitting diode (OLED), a vacuum fluorescent display (VFD), a field emission display (FED), or a micro display.

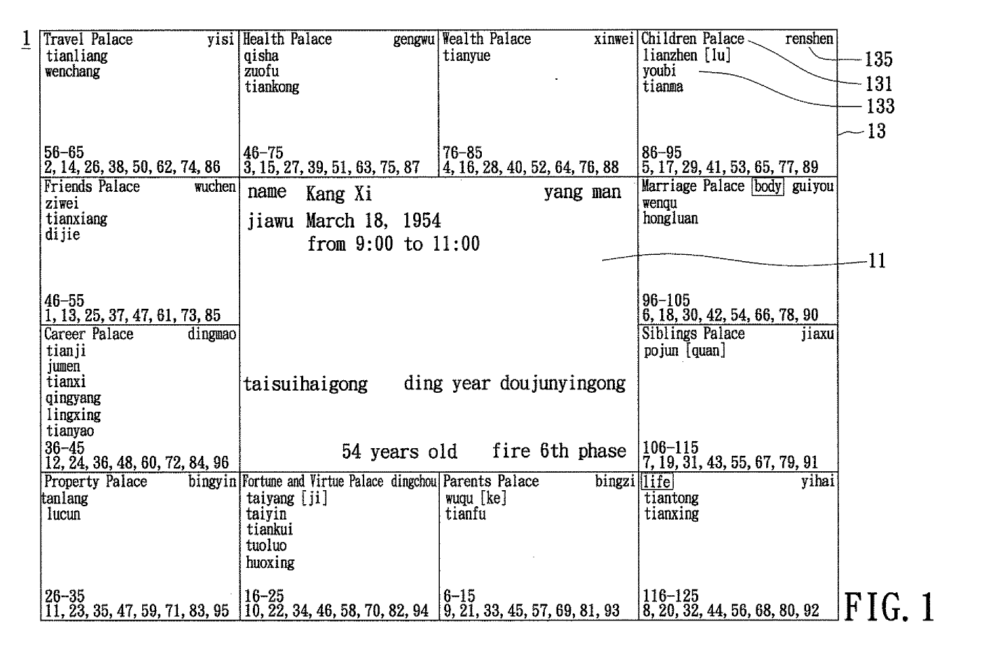

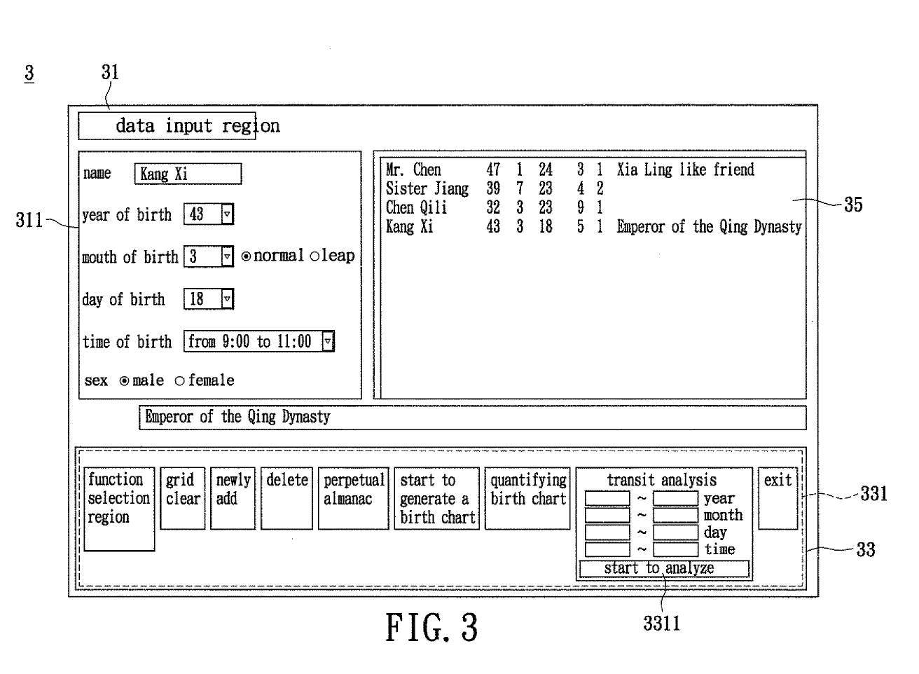

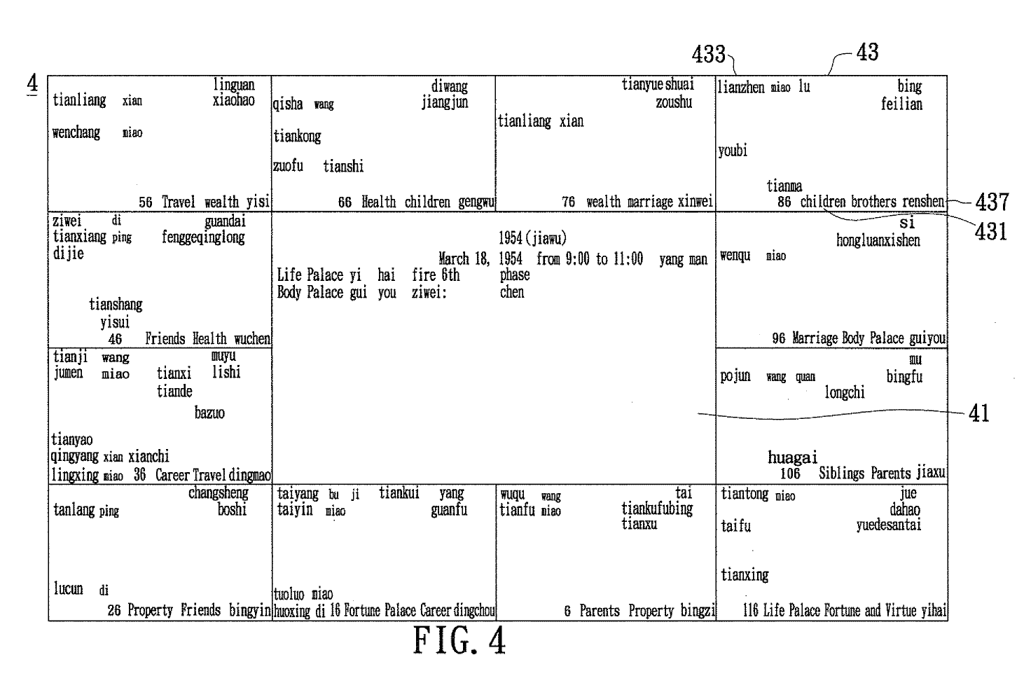

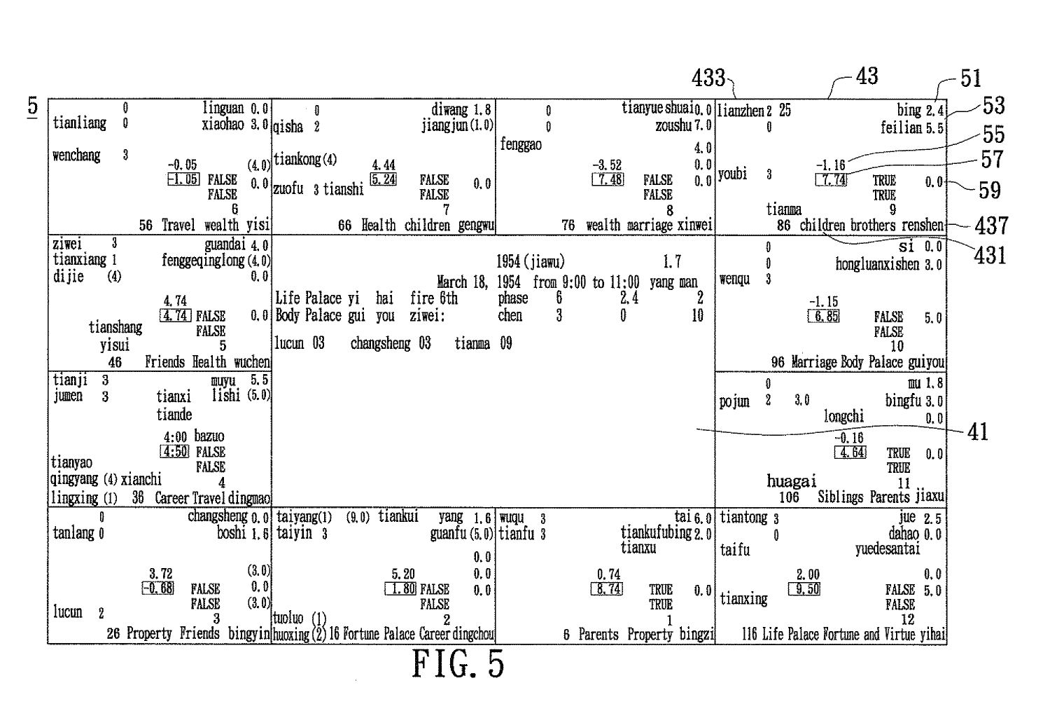

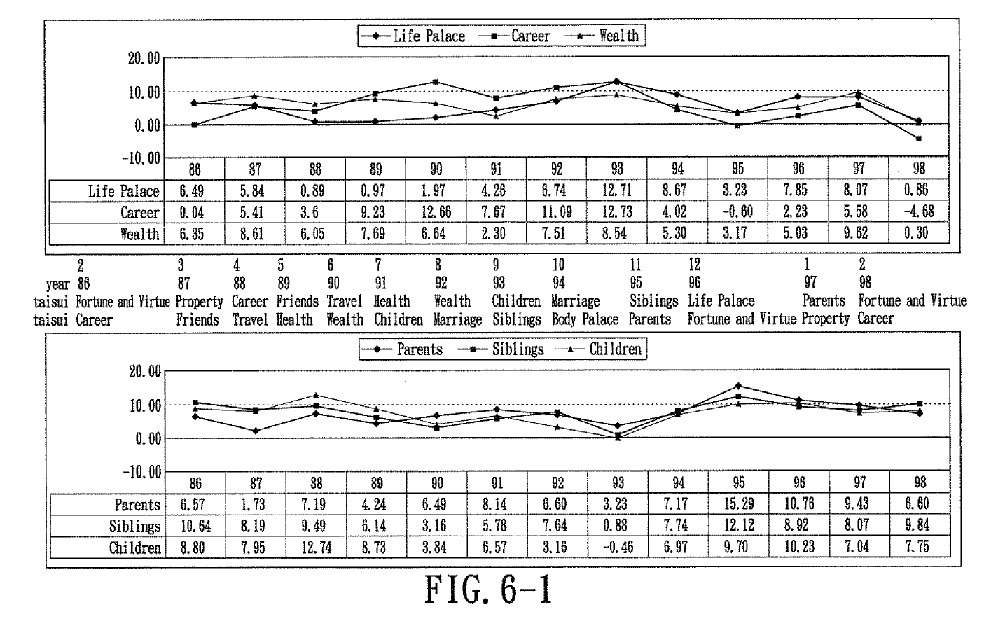

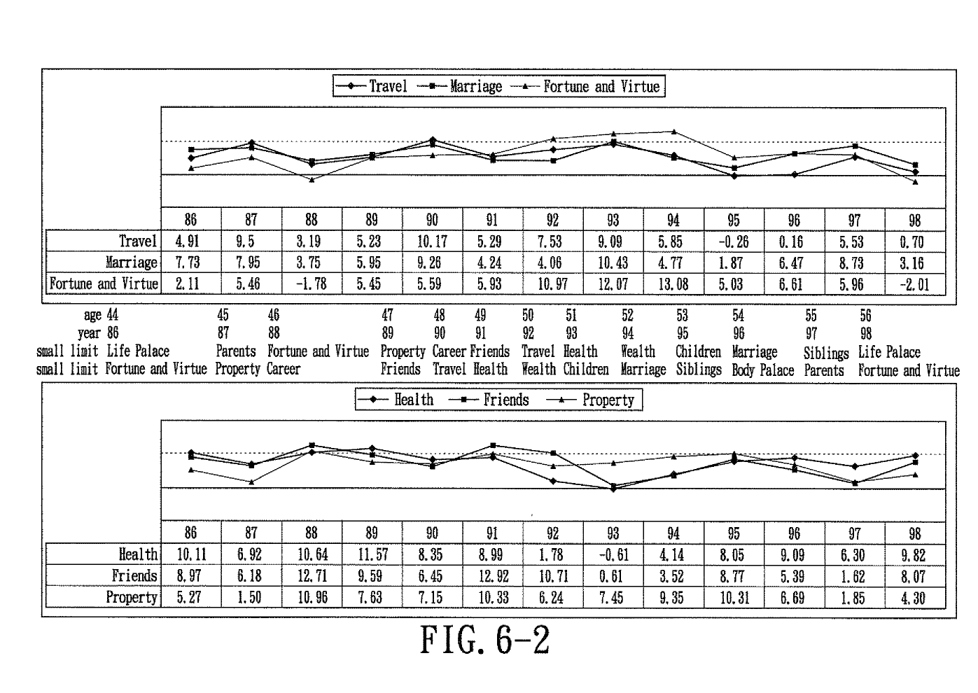

Please refer to FIG. 3 illustrating an operation interface of one embodiment of the Zi Wei Dou Shu analyzing system of the present invention, wherein regarding the system framework, please refer to FIG. 2 simultaneously; and regarding the operation screens, please refer to FIG. 4, FIG. 5, FIG. 6-1, 6-2 and Table 1, Table 2. As shown in FIG. 3, a software main screen 3 includes a datum input region 31, a function selection region 33, and a user list region 35. The datum input region 31 includes a plurality of grids 311 (or pull-down menus) for a user inputting his personal information via the input unit 211, wherein the personal information includes name, date of birth (including leap month), time of birth, sex, and so on of the user. The function selection region 33 includes a plurality of function keys 331. The user list region 35 lists the stored personal information.

When a user inputs his personal information in the datum input region 31 or selects the stored personal information from the user list region 35, and presses the function key 331 of “start to generate a birth chart”, the central processing unit 23 runs the chart generation program 2511 to generate a birth chart 4. As shown in FIG. 4, the birth chart 4 includes a center Palace grid 41 and twelve Palace grids 43 around the center Palace grid 41. The birth chart 4 lists the locations of the Palace grids 43 which fourteen major stars and a plurality of auxiliary stars falls into, and these stars may include six lucky stars, six unlucky stars, other large and small stars and four transformation stars that is based on heavenly stems of each year, and so on. The personal information and the information including the life and body sphere, the five elements and the Zi Wei (Polaris) location and so on which are achieved via calculation is listed in the center Palace grid 41. The Palace addresses of the twelve Palace grids 43, which need to be defined, are named as Life (Innate) Palace, Body (Acquired Life) Palace, Siblings (Brothers) Palace, Marriage (Spouse) Palace, Children Palace, Wealth Palace, Health (and Illness) Palace, Travel (Journey) Palace, Friends (and Servants) Palace, Career Palace, Properties Palace, Fortune and Virtue (Pleasure) Palace, and Parents Palace. Each Palace grid 43 lists the star falling into it, the name of the Palace address, the heavenly stem, the earthly branch, the major (10-year) and minor (1-year) time frame of life, and other information. Taking the Children Palace as the name of the Palace address for example, the heavenly stem and the earthly branch 437 are Ren Shen, the major star 433 falling into the Children Palace is Lian Zhen star, and the attribute 435 of the Lian Zhen star in the Children Palace in the time period from 15:00 PM to 17:00 PM (shen) is Miao.

After the birth chart 4 is generated, the user can press the function key 331 of “quantifying birth chart” to run the birth chart quantifying program 2513 so as to generate a quantified birth chart 5. As shown in FIG. 5, the quantified birth chart 5 shows the influence degree of constellations to every Palace grid 43 in a numerical mode. In each Palace grid 43, a Palace address fortune value 57 is achieved via the operation of at least one first (major star) parameter 51, one second (main auxiliary star) parameter 53 and one third (combination of stars at triplicity palaces) parameter 55. Taking the Children Palace for example, the heavenly stem and the earthly branch 437 are Ren Shen, the attribute of the Lian Zhen star of the major star 433 in the Children Palace in the time period from 15:00 PM to 17:00 PM (Shen) is Miao, so the corresponding value is 2.4 after searching Table 2, which is the first parameter 51. The second parameter 53 is determined by the combination of the main and auxiliary stars in every Palace address and the influence degree of the combination to the Palace address. The third parameter 55 is an amended value generated according to the triplicity. Finally, the sum of the first parameter 51, the second parameter 53, and the third parameter 55 is the fortune value 57 which means the fortune of the Children Palace of the user. The larger the fortune value 57 is, the better the fortune of the Palace grid 43 is, vice versa. In the same way, the remaining Palace grids 43 can calculate the fortune value of every Palace grid 43. Besides using the above described three parameters to amend the fortune value of every Palace grid 43, if there are special combinations (An He, Jia¹, Jia², etc.) of some other stars or special arrangement of stars, the corresponding parameter value 59 can be added to amend the fortune value 57, thereby achieving a more accurate fortune index. The parameter value 59 generated by the special arrangement of star will be shown in the right of every Palace grid 43 and have an effect on the fortune value of every Palace grid 43.

Then the user can input the time desired to be analyzed and press the function key 3311 of “start to analyze” to run the fortune analyzing program 2515 to generate a fortune analyzing table 6 according to the year, the month, the day, the time, and the major (10-year) and minor (1-year) time frame of life. As shown in FIG. 6-1˜6-2, the fortune analyzing table 6 expresses the fortune values of the twelve Palace addresses from 1997 to 2009 with numerical values and the fortune trend curve in a line chart. The present invention isn't limited to the embodiment and can choose to show the monthly fortune analyzing table, that is, express the fortune values of the twelve Palace addresses from January to December in some year with numerical values.

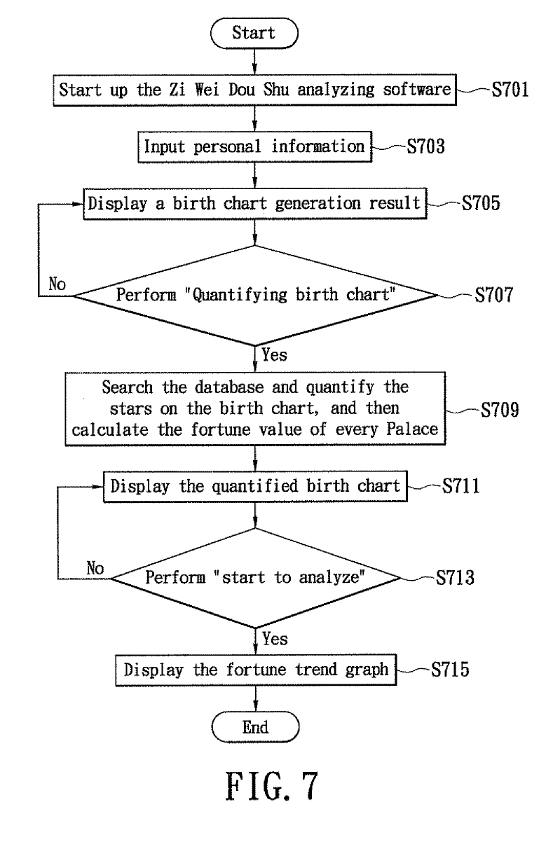

Please refer to FIG. 7 illustrating a flow chart of a Zi Wei Dou Shu analyzing method of the present invention, and please refer in conjunction to FIG. 2 and FIG. 3 illustrating the related system framework and the operation interface simultaneously. As shown in FIG. 7, the analyzing method includes the steps of:

Firstly, running the Zi Wei Dou Shu analyzing software 251 (Step S701) and inputting personal information (Step S703); the central processing unit 23 running the chart generation program 2511 to generate a birth chart according to the personal information (Step S705); judging whether pressing the function key of “quantifying birth chart” (Step S707), if Yes, then running the birth chart quantifying program 2513 to search the constellation intensity database 253 and calculate the fortune value of every Palace address according to the constellation combination, the major (10-year) and minor (1-year) time frame of life, and transits of time occurring in each Palace address (Step S709), and then displaying the quantified birth chart (Step S711); if not, then still displaying the screen of the birth chart; finally determine whether or not function key of “start to analyze” has been selected (Step S713), if Yes, then amending the quantified birth chart according to transits of time and displaying the fortune trend graph (Step S715); otherwise, still displaying the quantified birth chart.

The birth chart, the quantified birth chart, and the fortune trend graph may be shown in the user list region 35 or in another window, and may also be stored based on the storage program 2517 for reference in the future.

Accordingly, the Zi Wei Dou Shu analyzing system and method thereof of the present invention expresses the information in the birth chart in numerical values according to the major (10-year) and minor (1-year) time frame of life, the constellation combination, the transits of time, the combination on triplicity, and so on, and calculates the fortune trend in a period desired to be analyzed, thereby helping a user analyze the index of the birth chart and the reference direction of future fortune.

What are disclosed above are only the specification and the drawings of the preferred embodiment of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A Zi Wei Dou Shu analyzing system, comprising:
a storage module, storing a Zi Wei Dou Shu analyzing software and a constellation intensity database which records the degree of influence of a plurality of constellations on each Palace address in twelve Palace grids;
an input unit for a user inputting or recording personal information;
a central processing unit, coupled between the input unit and the storage module, for executing the Zi Wei Dou Shu analyzing software and collocating the constellation intensity database based on the personal information to generate a fortune analyzing result; and
a display unit, coupled with the central processing unit for displaying operation screens of the Zi Wei Dou Shu analyzing system.

2. The Zi Wei Dou Shu analyzing system as claimed in claim 1, wherein the Zi Wei Dou Shu analyzing software includes:
a chart generation program, generating a birth chart according to the personal information, the birth chart including a center Palace grid and a plurality of Palace grids around the center Palace grid and listing the personal information and some of the constellations;
a birth chart quantifying program, searching the constellation intensity database and converting information in the birth chart into numerical values according to a numerical value in every Palace grid of every constellation occurring in the birth chart, thereby generating a quantified birth chart; and
a fortune analyzing program, amending the quantified birth chart according to the transits of time to generate a fortune analyzing table.

3. The Zi Wei Dou Shu analyzing system as claimed in claim 1, wherein names of the Palace addresses of the twelve Palace grids are Life (Innate) Palace, Body (Acquired Life) Palace, Siblings (Brother) Palace, Marriage (Spouse) Palace, Children Palace, Wealth Palace, Health (and Illness) Palace, Travel (Journey) Palace, Friends (and Servants) Palace, Career Palace, Properties Palace, Fortune and Virtue (Pleasure) Palace, and Parents Palace.

4. The Zi Wei Dou Shu analyzing system as claimed in claim 1, wherein the plurality of constellations includes fourteen major stars and a plurality of auxiliary stars which include large and small stars such as six lucky stars, six unlucky stars, Lu Cun, Hong Luan, Tian Xi, Tian Yao, 12 Chang Sheng stars, 12 Bo Shi stars, and four transformation stars that is based on heavenly stems of each year.

5. The Zi Wei Dou Shu analyzing system as claimed in claim 1, wherein the personal information includes the user's name, sex, year and month of birth (including leap month), and date and time of birth.

6. The Zi Wei Dou Shu analyzing system as claimed in claim 1, wherein the display unit is selected from a liquid crystal display, an organic light-emitting diode, a vacuum fluorescent display, a field emission display, or a micro display.

7. The Zi Wei Dou Shu analyzing system as claimed in claim 2, wherein the central processing unit has a window to display the birth chart, the quantified birth chart or the fortune analyzing table on the display unit.

8. The Zi Wei Dou Shu analyzing system as claimed in claim 2, wherein the fortune analyzing program generates the fortune analyzing table according to major (10-year) time frame of life, and transits of the year (including minor (1-year) time frame of life and location of Tai Sui (year-star)), and years, months, days, and time for displaying.

9. A Zi Wei Dou Shu analyzing method, comprising:
executing a Zi Wei Dou Shu analyzing software;
inputting personal information;
executing a chart generation program to generating a birth chart according to the personal information;
executing a birth chart quantifying program by using numerical values so as to express influence degrees of every information occurring in the birth chart thereby generating a quantified birth chart; and
running a fortune analyzing program to amend the quantified birth chart according to transits of time so as to generate a fortune analyzing table.

10. The Zi Wei Dou Shu analyzing method as claimed in claim 9, further opening at least one window to display the birth chart, the quantified birth chart, or the fortune analyzing table.

11. The Zi Wei Dou Shu analyzing method as claimed in claim 9, wherein the information occurring in the birth chart includes fourteen major stars and a plurality of auxiliary stars and is calculated to be different numerical values according to different locations in the birth chart, constellation combinations, and personal information.

12. The Zi Wei Dou Shu analyzing method as claimed in claim 9, wherein the fortune analyzing program generates the fortune analyzing table according to 10-year frame, transits of year (including 1-year frame and location of Tai Sui (year-star)), months of the year, days of the month, and hourly time of the day.

13. The Zi Wei Dou Shu analyzing method as claimed in claim 9, further comprising the steps of:
providing an operation interface for input of the personal information;
executing a storage program for storage the personal information, the birth chart, the quantified birth chart, or the fortune analyzing table.

14. The Zi Wei Dou Shu analyzing method as claimed in claim 12, wherein the fortune analyzing table expresses a period of fortune trend in a line chart.

15. A machine-readable storage medium which stores a software code segment, wherein when the software code segment is executed on a computer system, the software code segment makes the computer system perform the method as claimed in claim 9, 10, 11, 12, 13 or 14.

16. The machine-readable storage medium as claimed in claim 15, wherein the computer system is executed on a desktop personal computer, a notebook computer, a server, an ultra mobile personal computer, a smartphone, a personal digital assistant (PDA), or a terminal device related to wireless transmission.
